(19) United States
(12) Patent Application Publication
(10) Pub. No.: US 2018/0217349 A1
(43) Pub. Date: Aug. 2, 2018

(54) DIFFRACTION GRATING GIMBAL MOUNT

(71) Applicant: Newport Corporation, Irvine, CA (US)

(72) Inventors: Wen Xu Jin, Laguna Hills, CA (US); Rick Sebastian, Costa Mesa, CA (US)

(73) Assignee: Newport Corporation, Irvine, CA (US)

(21) Appl. No.: 15/880,127

(22) Filed: Jan. 25, 2018

Related U.S. Application Data
(60) Provisional application No. 62/451,748, filed on Jan. 29, 2017.

(51) Int. Cl. G02B 7/02; G02B 27/09; F16M 11/06

(52) U.S. Cl. CPC G02B 7/02; F16M 11/06; G02B 27/0944

(57) ABSTRACT

The present application discloses a mount for an optical component having a least one support assembly having at least one support body, at least one adjustment assembly having at least one adjustment body and in communication with the support assembly, the adjustment assembly having at least one first adjustment device configured to rotate the support assembly about at least one first axis, at least one second adjustment device configured to rotate the support assembly about at least one second axis substantially orthogonal to the first axis, and at least one third adjustment device configured to rotate the support assembly about at least one third axis, the third axis being orthogonal to the first axis and the second axis, wherein the at least one first axis, the at least one second axis and the at least one third axis are configured to substantially overlap at least one selected point.

### CROSS-REFERENCE TO RELATED APPLICATIONS

The present application claims priority to U.S. Provisional Patent Application Ser. No. 62/451,748—titled “Diffraction Grating Gimbal Mount”, filed on Jan. 29, 2017, the contents of which are incorporated by reference in their entirety herein.

### BACKGROUND

Optical systems typically comprise a plurality of components including laser sources, mirrors, diffraction gratings, beam splitters, and other optical components. Such systems require a high degree of positional accuracy and precision during use. In the past, mounts for various optical components provided adjustment of optical components in multiple degrees of freedom. Optical mounts that provide rotational adjustment often require subsequent linear adjustments to account for changes in the location of the surface of the optical component, requiring time-consuming iterative adjustments to achieve the desired positioning precision. In light of the foregoing, there is an ongoing need for an optical mount capable of adjustment of rotation around multiple axes with minimal or no subsequent linear adjustments.

### SUMMARY

The present application is directed to a novel mount for an optical component. More specifically, the optical mount device disclosed herein permits the user to selectively adjust the tilt of the optical component about three orthogonal axes while minimizing subsequent adjustments in the relative position of the optical component. In one embodiment, the present application discloses an optical component mount with at least one support assembly with at least one support body configured to support the optical component, and at least one adjustment assembly with at least one adjustment body, in communication with the support assembly. At least one first adjustment device is positioned on the adjustment body and is configured to engage and rotate the support assembly about a first axis. A second adjustment device is positioned on the adjustment body and is configured to engage and rotate the support assembly about a second axis substantially orthogonal to the first axis. A third adjustment device is positioned on the adjustment body and is configured to engage and rotate the support assembly about a third axis that is substantially orthogonal to the first axis and the second axis, wherein the first axis, the second axis and the third axis substantially overlap at least one selected point. The selected point may be on the surface of an optical component or elsewhere on or near the optical component.

In another embodiment, present application discloses an optical component mount that comprises at least one support assembly for supporting the optical component, the support assembly configured to support at least one optical component. At least one adjustment assembly with at least one adjustment body is in communication with the support assembly, with at least one first adjustment device positioned on the adjustment body and configured to engage and rotate the support assembly about a first axis. At least one second adjustment device is positioned on the adjustment body and is configured to engage and rotate the support assembly about at least a second axis that is substantially orthogonal to the first axis. At least one third adjustment device is positioned on the adjustment body is and configured to engage and rotate the support assembly about a third axis that is substantially orthogonal to the first axis and the second axis, wherein the first axis, the second axis and the third axis substantially overlap a selected point. Further, at least one coupler channel is formed on the adjustment body, defining a fourth axis that substantially overlaps at least one of the first, second or third axes, the coupler channel configured to receive at least one fastener configured to couple the adjustment body to at least one optical post or work surface structure.

In yet another embodiment, the present application discloses an optical component mount with at least one support assembly having at least one support body with at least one optical component receiving area formed therein. At least one adjustment assembly with at least one adjustment body is provided, the adjustment assembly in communication with the support assembly. At least one first pivot assist surface is formed in the support body and is configured to receive at least one pivot body, and at least one second pivot assist surface is formed in the adjustment body and is configured to receive at least one pivot body. At least one pivot body with at least one pivot body center is positioned between the first pivot assist surface of the support body and the second pivot assist surface of the adjustment body. At least one first adjustment device is positioned on the adjustment body and is configured to engage and rotate the support assembly about a first axis, the first axis substantially overlapping the pivot body center. At least one second adjustment device is positioned on the adjustment body and is configured to engage and rotate the support assembly about at least a second axis that is substantially orthogonal to the first axis and substantially overlapping the pivot body center. At least one third adjustment device is positioned on the adjustment body and is configured to engage and rotate the support assembly about a third axis that is substantially orthogonal to the first axis and the second axis, wherein the first, second, and third axes substantially overlap the pivot body center.

Other features and benefits of the embodiments of the novel diffraction grating gimbal mount as disclosed will become apparent from a consideration of the following detailed description.

### BRIEF DESCRIPTION OF THE DRAWINGS

Various embodiments of the diffraction grating gimbal mount will be explained in more detail by way of the accompanying drawings, wherein:

FIG. 1 shows an elevated perspective view of an embodiment of a diffraction grating gimbal mount coupled to an optical post;

FIG. 2 shows an elevated perspective front view of an embodiment of a diffraction grating gimbal mount;

FIG. 3 shows an elevated perspective rear view of an embodiment of a diffraction grating gimbal mount;

FIG. 4 shows a section view of an embodiment of a diffraction grating gimbal mount;

FIG. 5 shows a section view of a section view of an embodiment of a diffraction grating gimbal mount;

FIGS. 6 and 7 show perspective views of an embodiment of a support body of a diffraction grating gimbal mount;

FIGS. 8 and 9 show perspective views of an embodiment of an adjustment body of a diffraction grating gimbal mount;

FIG. 10 shows an elevated perspective view of another embodiment of a diffraction grating gimbal mount coupled to an optical post;

FIG. 11 shows an elevated perspective front view of another embodiment of a diffraction grating gimbal mount;

FIG. 12 shows an elevated perspective rear view of another embodiment of a diffraction grating gimbal mount;

FIG. 13 shows a section view of an embodiment of a diffraction grating gimbal mount;

FIGS. 14 and 15 show perspective views of an embodiment of a support body of a diffraction grating gimbal mount;

FIGS. 16 and 17 show perspective views of an embodiment of an adjustment body of a diffraction grating gimbal mount;

FIG. 18 shows a section view of an embodiment of a diffraction grating gimbal mount; and

FIG. 19 shows a perspective bottom view of an embodiment of a diffraction grating gimbal mount.

### DETAILED DESCRIPTION

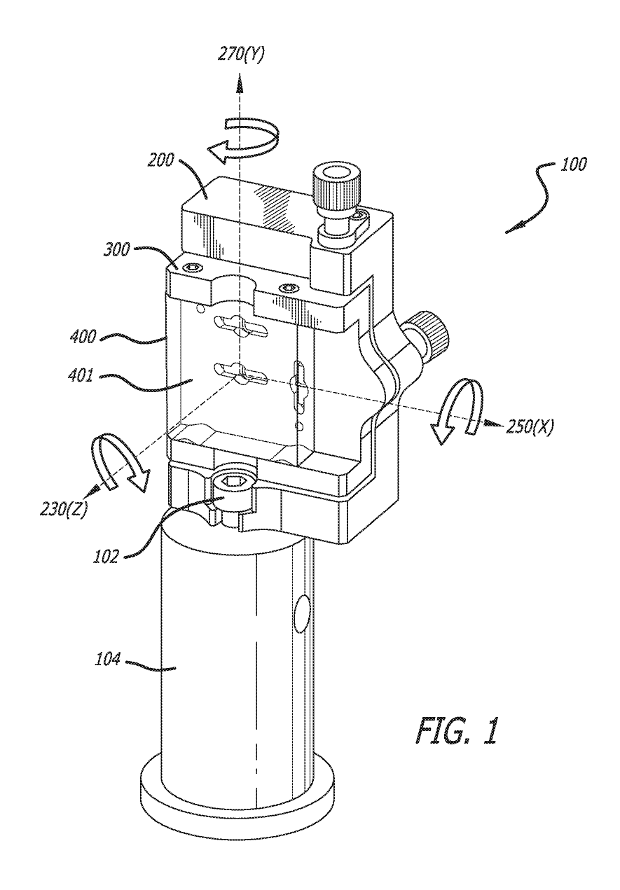

FIGS. 1-3 illustrate various perspective views of an embodiment of a diffraction grating gimbal mount 100 (hereinafter the “mount 100”) configured to support at least one optical component 400 having at least one optical component body. As shown, the mount 100 provides for independent adjustment of the angular orientation of the mounted optical component 400 about one or more rotational axes. The orientation adjustments may be made manually and/or by actuator control, as discussed in more detail below. The exemplary mount 100 may be configured to support and adjust the orientation of a wide variety of optical components 400, such as diffraction gratings, mirrors, beam splitters, reflective components, transmissive components, and the like. In particular, the exemplary mount 100 comprises at least three assemblies. In the illustrated embodiment, these assemblies include at least one adjustment assembly 200, at least one biasing system 500 and 510, and at least one support assembly 300 configured to securely retain at least one optical component 400 therein or coupled thereto. Those skilled in the art will appreciate that the mount 100 may comprise any number of assemblies.

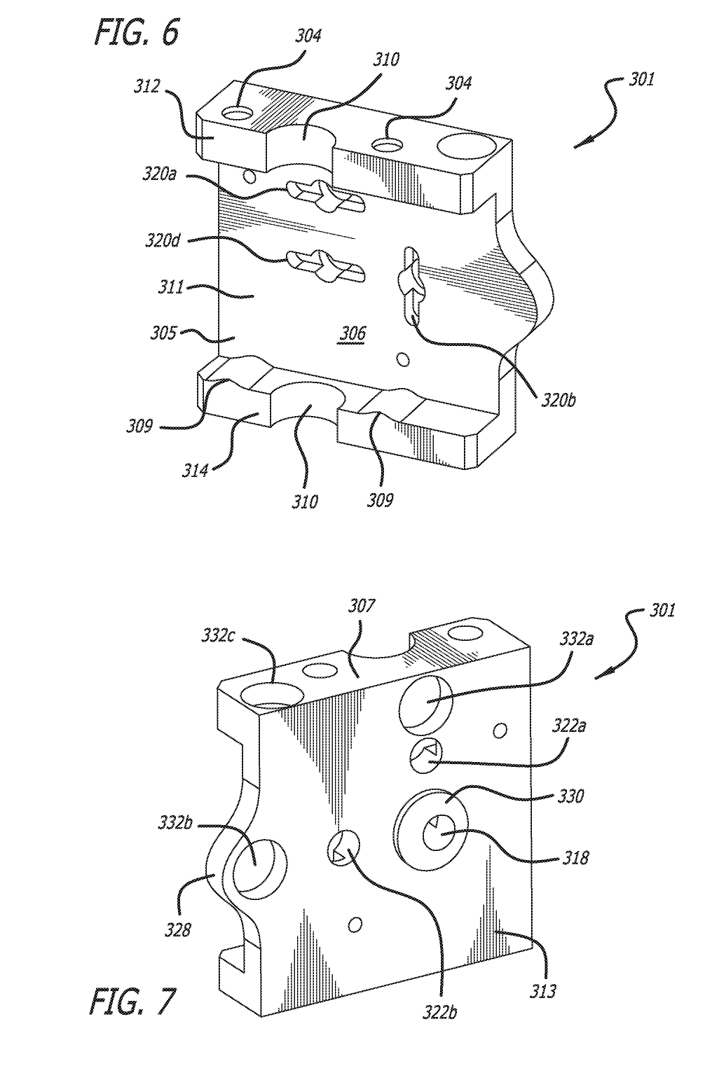

As shown in FIGS. 1, 2, 6 and 7, the support assembly 300 secures the optical component 400 within a component receiving area 306 with one or more securing devices 303. Exemplary securing devices include nylon screws, set screws, nylon-tipped set screws, springs and the like. In the illustrated embodiment, the securing device 303 is a nylon-tipped set screw that traverses through at least one securing device passage 304 (see FIGS. 6 and 7) and engages with the optical component 400 to secure the optical component 400 to the support assembly 300. In the illustrated embodiment, the support assembly 300 secures the optical component 400 in a vertical orientation. Optionally, the support assembly 300 securely supports the optical component 400 in a horizontal orientation or any other orientation. The adjustment assembly 200 is configured to receive the support assembly 300 and provide one or more adjustment devices 220 to affect changes to the angular orientation of the support assembly 300.

As shown in FIGS. 1-5, the adjustment assembly 200 may provide for the rotation of the support assembly 300 about at least one of the X-axis 250 (pitch), a Y-axis 270 (yaw) and a Z-axis 230 (roll), wherein these axes may substantially overlap at a selected point. In one embodiment, the selected point may be proximal to at least one surface 401 of the optical component 400 that is fixed in the optical component receiving area 306 of the support body 301. In another embodiment, the selected point may be located within the body of the optical component 400. In another embodiment, the selected point may be located proximal to at least one surface 305 of the support body 301. In other embodiment, the selected point may be located proximal to at least one surface 211 of the adjustment body 201. Optionally, the selected point may be located anywhere on or around the diffraction grating gimbal mount 100 or the optical component 400.

For example, in the illustrated embodiment, the adjustment assembly 200 comprises at least one pitch adjustment device 220a, at least one yaw adjustment device 220b and at least one roll adjustment device 220b such that engagement of the adjustment devices 220a-c provides angular orientation adjustment of the support assembly 300 to orient the surface 401 of the optical component 400. Those skilled in the art will appreciate that any number of adjustment devices 220 may be used with the adjustment assembly 200.

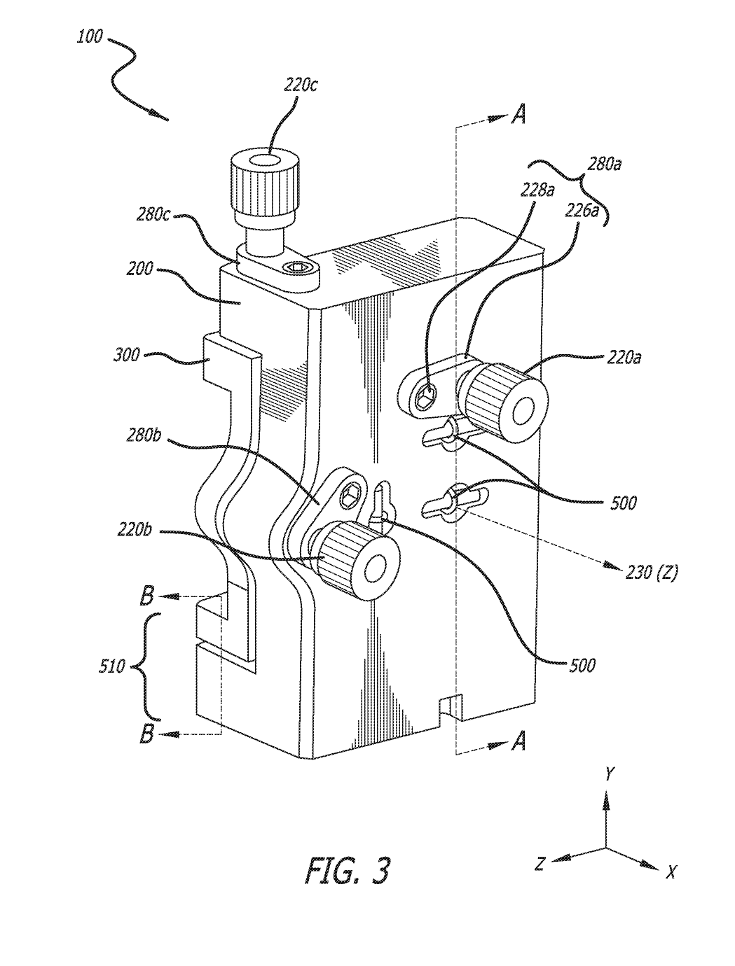

As shown in FIGS. 3-9, at least one adjustment device 220 may be used to selectively adjust the position of at least one optical component 400 coupled to the mount 100. As shown, the adjustment device 220a comprises at least one adjustment effector 224a attached to or integral with at least one adjustment member 222a that traverses through at least one adjustment member passage 225a of the adjustment body 201. Optionally, an external tool (not shown) such as a hex key or wrench may be inserted through at least one of the passages 221a, the adjustment effector 224a, or both and configured to engage the adjustment member 222a. In the illustrated embodiment, the adjustment member passage 225a has internal threads and the adjustment member 222a has external threads. Exemplary adjustment members 222a-c include coarse-threaded screws with about 20 threads per inch and screws with fine threads, such as 80, 100, 127, 170, 254, or any number of threads per inch. Screws with finer threads enable smoother and more precise control for orientation of the optical component 400. Optionally, the adjustment devices 220a-c may comprise thread-matched adjustment screws, micrometer actuators, piezo-driven rotational actuators, servo-driven rotational actuators, piezo-driven linear actuators and servo-driven linear actuators. Those skilled in the art will appreciate that adjustment devices 220b, 220c may include a similar architecture to adjustment device 220a. Optionally, at least one of the adjustment devices 220, 220b, 220c may include an alternate design known in the art. Those skilled in the art will appreciate that many types of actuators may be employed in the adjustment devices 220a-c. In the illustrated embodiment, the adjustment members 222a-c are manufactured from steel. Optionally, the adjustment members 222a-c may be manufactured from any variety of materials, including, without limitations, corrosion-resistant steel, copper, brass, bronze, tungsten, various alloys, composite materials, and the like. The adjustment devices 220a-220c and/or the support assembly 300 and/or the adjustment assembly 200 may also comprise temperature-compensating devices that reduce or eliminate changes in the dimensions of the mount 100 due to changes in ambient temperature. Such temperature-compensating devices are described in U.S. patent application Ser. No. 15/713,570—titled “Thermal Compensating Optical Mount and Related Devices”—the contents of which are incorporated herein by reference. In addition, any electronically controlled actuators may be connected to a control system that enables remote control of three axes of motion of the mount 100.

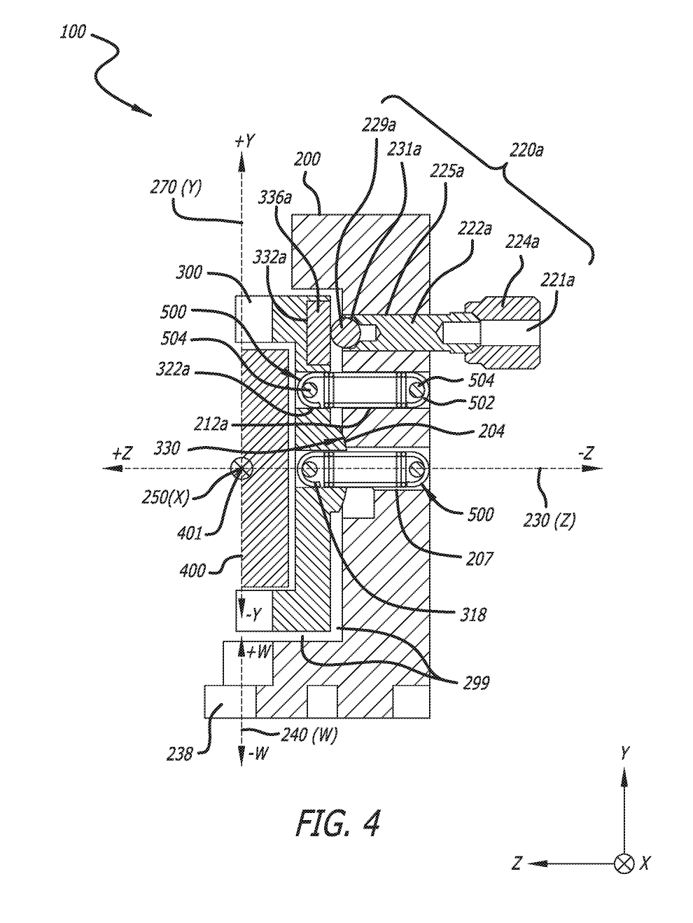

FIG. 4 illustrates a side sectional view A-A of the mount 100. In the illustrated embodiment, the adjustment member 222a comprises at least one engaging member 229a disposed in an engaging member receiving area 231a. The engaging member 229a abuts at least one engaging body 336a that is disposed in at least one engaging body receiving area 332a (see FIGS. 6 and 7) formed in the support body 301. Optionally, the engaging member 229a may contact the surface 313 of the support body 301 (see FIGS. 6 and 7) directly, without the use of the engaging body 336a. Optionally, the adjustment member 222a need not comprise an engaging member 229a but instead be formed as a monolithic body with a rounded, conical, flat or any other shape end that abuts the engaging body 336a or the surface 313. In one embodiment, the engaging body 336a is manufactured from carbide. Optionally, the engaging body 336a is manufactured from at least one material selected from the group consisting of steel, aluminum, alloys, tungsten, sapphire, composite materials, polymers, elastomers, and the like.

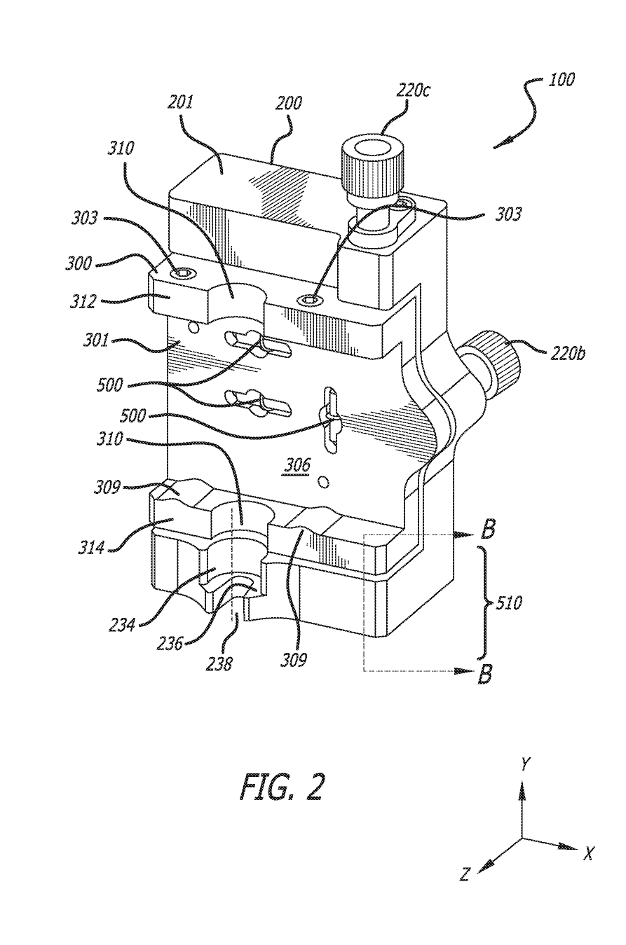

Referring to FIGS. 2-9, at least one biasing system 500 is configured to provide a biasing force to the adjustment device 220c, having at least one biasing body 502 and at least one biasing system retention member 504. In one embodiment, the biasing body 502 may traverse through at least one biasing member passage 322a-b formed in the support body 301, through the at least one positioning relief 299, and the biasing passage 212a-b formed in the adjustment body 201. The biasing body 502 may be retained by the biasing system retention member 504 positioned in at least one of the retaining device receivers 223, 320 formed in the adjustment body 201 and the support body 301, respectively. For example, in one embodiment, the biasing body 502 comprises a spring device. Exemplary materials for the biasing body 502 are spring steel, corrosion-resistant steel, nickel-based super-alloys, shape-memory alloys, super-elastic alloys, and the like. Optionally, the biasing body 502 may comprise a leaf spring, flexure device, kinematic biasing device or other device that provides a biasing force to urge the support assembly 300 against the adjustment device 220a. During use, the biasing system 500 is configured to couple the adjustment assembly 200 and the support assembly 300 in a movable relation. As such, at least a portion of the biasing system 500 is configured to traverse through at least one positioning relief 299 formed between the support assembly 300 and the adjustment assembly 200. Those skilled in the art will appreciate that any number of biasing systems of any variety may be used with the mount 100.

As shown in FIGS. 2-4, in the illustrated embodiment, when the adjustment effector 224a is actuated in a first direction, the adjustment member 222a moves in the positive Z-direction, causing the support assembly 300 to pivot in a second, opposing direction (around the X axis 250 from the perspective of FIG. 4) against the biasing force of the biasing system 500, resulting in a change in the angular orientation of the optical component 400. When the adjustment effector 224a is turned in the second direction, the adjustment member 222a moves in the negative Z-direction, and the biasing system 500 forces the support assembly 300 to pivot in the first direction (around the X axis 250 shown in FIG. 4). The adjustment device 220a may be removable and replaced with the optional adjustment devices or actuators described above for mechanically or electronically adjusting the orientation of the optical component 400 about the X-axis 250 (pitch).

Referring to FIGS. 1-4, the adjustment assembly 200 shows at least three adjustment devices 220a-c, each configured to provide motion of the support assembly 300 relative to the adjustment assembly 200. As such, in a similar manner to that described above, the adjustment device 220b adjusts the support assembly 300 about the Y-axis 250 (yaw), and the adjustment device 220c adjusts the support assembly 300 about the Z-axis (roll).

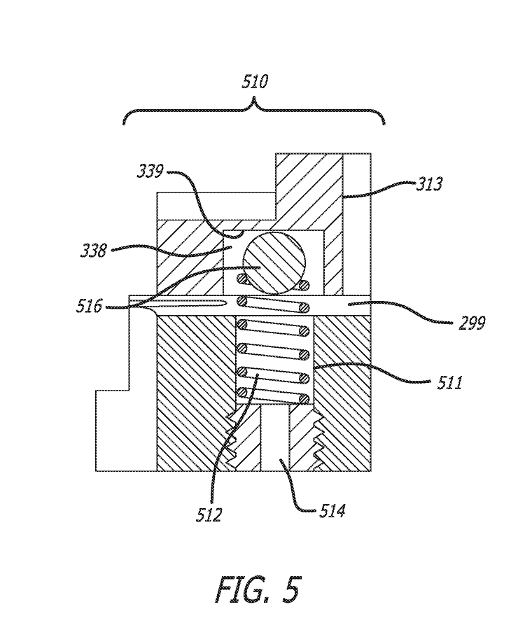

As shown in FIGS. 2-5, 8, and 9, at least one biasing system 510 is configured to provide biasing force to the adjustment device 220c for the Z-axis (roll) (see section B-B in FIG. 5). At least one biasing body passage 511 is formed in the flange 218 of the adjustment body 201. At least one biasing body 512 traverses through at least one biasing body passage 511 and the positioning relief 299 and engages with at least one engaging member 516 located within at least one biasing system relief 338 formed in the support body 301. Optionally, the biasing body 512 may contact at least one surface 339 formed in the biasing system relief 338 directly without the engaging member 516. The biasing body 512 is retained in the biasing body passage 511 by at least one biasing body retainer 514. In the illustrated embodiment, the biasing body 512 is a spring, although any variety of other devices may be used to form the biasing body 512. Exemplary materials for the biasing body 512 are spring steel, corrosion-resistant steel, nickel-based super-alloys, shape-memory alloys, super-elastic alloys, and the like. Optionally, the biasing body 512 may comprise a leaf spring, flexure device, kinematic biasing device or other device that provides a biasing force to urge the support assembly 300 against the adjustment device 220c.

Referring to FIGS. 1-9, as discussed above, the adjustment assembly 200 comprises at least three adjustment devices 220a-c. Each of the adjustment devices 220a-c operates with a corresponding biasing system 500 and/or 510 to provide a biasing force that urges the support assembly 300 against the adjustment devices, thereby resulting in controlled changes in orientation of the optical component 400.

Referring to FIGS. 3-9, in the illustrated embodiment, at least one biasing system 500 traverses through at least one passage 207 of the adjustment body 201 and at least one passage 318 formed in the support body 301. The biasing system retaining members 504 are positioned within the biasing member recesses in the retaining device receivers 320d and 223d respectively. As such, the biasing system 500 urges at least one pivot assist surface 330 of the support body 301 against at least one pivot assist surface 204 formed in the adjustment body 201. In the illustrated embodiment, the pivot assist surface 204 is formed coaxially with the passage 207. In another embodiment, the pivot assist surface 204 need not be formed coaxially with passage 207. In the illustrated embodiment, the pivot assist surface 204 is spherical. Optionally, the pivot assist surface 204 may be conical or elliptical or any other shape that would facilitate rotational adjustments of the support assembly 300 relative to the adjustment assembly 200. In one embodiment, at least one relief feature 206 is formed in the adjustment body 201 proximate to the passage 207. Alternatively, relief features 206 need not be formed in the adjustment body 201. During use of the diffraction grating gimbal mount, the pivot assist surface 330 and the pivot assist surface 204 may slide relative to each other (see FIG. 4). Friction between the pivot assist surfaces 330 and 204 may prevent the smooth continuous motion of the support assembly 300 relative to the adjustment assembly 200. The relief feature 206 may reduce the area of contact between the pivot assist surface 330 and the pivot assist surface 204, thereby reducing friction during operation. Those skilled in the art will appreciate that other configurations of the pivot assist surfaces may also serve to reduce friction. Exemplary approaches include the use of a friction reducing device such as a bearing between the pivot assist surface 330 and the pivot assist surface 204. Also, friction-reducing coatings may be applied to the support body 301 and/or the adjustment body 201. Optionally, lubricants may be used between the pivot assist surface 330 and the pivot assist surface 204. Lubricants may include Teflon, molybdenum disulfide, oils, greases and other materials known in the art to reduce friction.

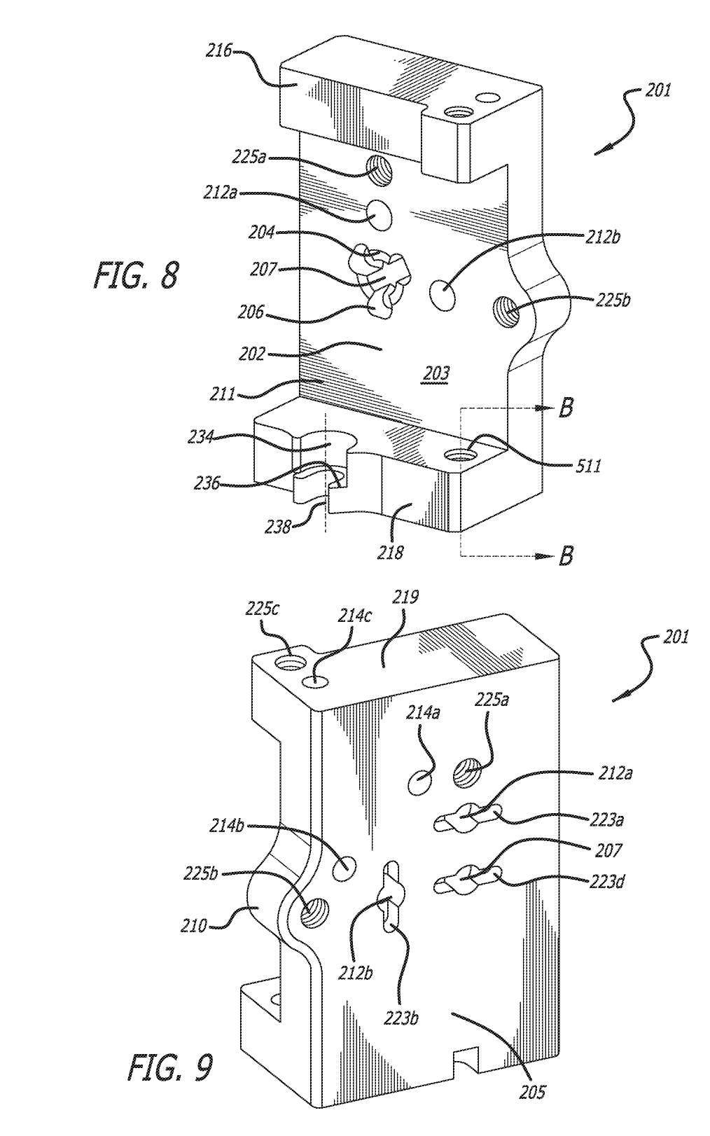

As shown in FIGS. 3, 4, 8, and 9, the adjustment assembly 200 may further comprise at least one adjustment member lock 280a for selectively preventing the movement of the X-axis adjustment device 220a when set to a desired orientation. The adjustment member lock 280a comprises at least one locking member 226a in communication with the adjustment member 222a located at the proximal region of the locking member 226a. Additionally, the adjustment member lock 280a may further include at least one fastener device 228a situated within the distal portion of the locking member 226a. The fastener device 228a may engage with at least one locking member receiving area 214a that is formed in the adjustment body 201 (see FIGS. 8 and 9) and urge the distal portion of the locking member 226a from the surface 205, thereby preventing the movement of the adjustment member 222a. Optionally, the fastener device 228a may contact the surface 205 of the adjustment body 201 directly. Those skilled in the art will appreciate that other adjustment member locks known in the art may be employed to hold the adjustment member 222a in a desired location. As shown in FIGS. 1-3, the adjustment assembly 200 shows that all three adjustment devices 220a, 220b and 220c are configured with corresponding adjustment member locks 280a, 280b and 280c respectively. Optionally, the adjustment devices 220a-c may operate without the adjustment member locks 280a-c.

As shown in FIGS. 6 and 7, the support body 301 comprises at least one plate body 311 with one or more surfaces 305 and 313 and with one or more flanges 312 and 314 formed thereon or integral thereto. In one embodiment, the flanges 312 and 314 are formed on the plate body 311 to create a monolithic body. In another embodiment, the plate body 311 and flanges 312 and 314 are formed from separate members. In the illustrated embodiment, the plate body 311 and the flanges 312 and 314 define at least one optical component receiving area 306. In the illustrated embodiment, the flanges 312 and 314 are horizontally arranged. Optionally, the flanges 312 and 314 may be vertically arranged or arranged in other orientations. The support body 301 further comprises at least one feature 309 formed on the flange 314 and configured to support the optical component 400. At least one securing device passage 304 is formed in the flange 312. In the illustrated embodiment, at least one engaging body receiving area 332c is formed in the surface 307 of the support body 301. In another embodiment, the support body 301 need not include an engaging member receiving area 332c. At least one relief 310 is formed in flange 312 and in flange 314, being substantially coaxial with each other to allow access to the fastener 102 (see FIG. 1). In the illustrated embodiment, the relief 310 is arcuate. Optionally, the relief 310 may be square, rectangular, triangular, or other shape. At least one pivot assist surface 330 is formed on the surface 313 of the support body 301. At least one passage 318 extends from the surface 305 through the pivot assist surface 330. Optionally, no passage is formed through pivot assist surface 330. At least one extended area 328 is formed on the plate body 311, with at least one engaging body receiving area 332b formed therein. Optionally, the extended area 328 may not have the engaging body receiving area 332b formed therein.

In the illustrated embodiments, the support body 301 and the adjustment body 201 are made from aluminum. Optionally, the support body 301 and the adjustment body 201 may be made from steel, corrosion-resistant steel, sintered metals, titanium, shape-memory alloys, super-alloys such as Inconel, Kovar, Invar and others, thermoplastics, thermoset polymers, carbon-fiber reinforced plastics and the like. Those skilled in the art will appreciate that the support body 301 and the adjustment body 201 may be made from any variety of materials.

Referring to FIGS. 8 and 9, in one embodiment, the adjustment body 201 comprises at least one plate body 202 having surfaces 211 and 205 formed thereon and with one or more flanges 216 and 218 formed thereon or integral thereto, defining at least one support body receiving area 203. In one embodiment, the flanges 216 and 218 are formed on the plate body 202 to form a monolithic adjustment body 201. In another embodiment, the plate body 202 and the flanges 216 and 218 are formed from separate members. In the illustrated embodiment, flanges 216 and 218 are horizontally arranged. Optionally, flanges 216 and 218 may be vertically arranged or arranged in other orientations. In the illustrated embodiment, the support body 201 further comprises at least one extended region 210 formed on the plate body 202. At least one passage 225b is formed in the extended region 210. The passage 225b is configured to receive the adjustment device 220b for the yaw adjustment of the support assembly 300. In similar fashion, at least one passage 225c is formed in the surface 219 of the adjustment body 201, with at least one locking member receiving area 214c formed proximal thereto. The passage 225c is configured to receive the adjustment device 220c for roll adjustment of the support assembly 300.

As shown in FIGS. 1, 2, 8, and 9, in one embodiment, the mount 100 may include at least one coupler channel 234 or similar feature permitting the optical mount 100 to be selectively coupled to or movably coupled to at least one optical post 104, fixture, structure and/or similar component. For example, in the illustrated embodiment, the mount 100 includes a single coupler channel 234 formed in at least a portion of the flange 218. As shown, the coupler channel 234 may include at least one fastener recess 238 and at least one fastener flange 236 formed within the coupler channel 234. Further, as shown, in one embodiment the fastener recess 238 traverses through the flange 218, thereby permitting at least one fastener 102 positioned within the coupler channel 234 to selectively engage and be retained by the optical post 104. For example, during use the user may position at least one fastener 102 within the coupler channel 234 and actuate the fastener 102 such that the fastener engages the fastener flange 236, traverses through the flange 218 and engages at least a portion of the optical post 104, thereby securely coupling the mount 100 to the optical post 104.

In one embodiment, the coupler channel 234 and/or the fastener recess 238 may define at least one fourth, W-axis 240. In one embodiment, the W-axis 240 may substantially overlap one or more of the X-axis 250, the Y-axis 270 and the Z-axis 230 (see FIG. 4). In this embodiment, the coupler channel 234 and/or the fastener recess 238 are formed such that the centerline of the fastener 102 may align with the surface 401 of the optical component 400 and the Y-axis of the mount 100, providing positional adjustment of the mount 100 about the Y-axis without requiring subsequent linear adjustments of the mount 100. Optionally, the W-axis 240 may overlap none of the X-axis 250, the Y-axis 270 or the Z-axis 230.

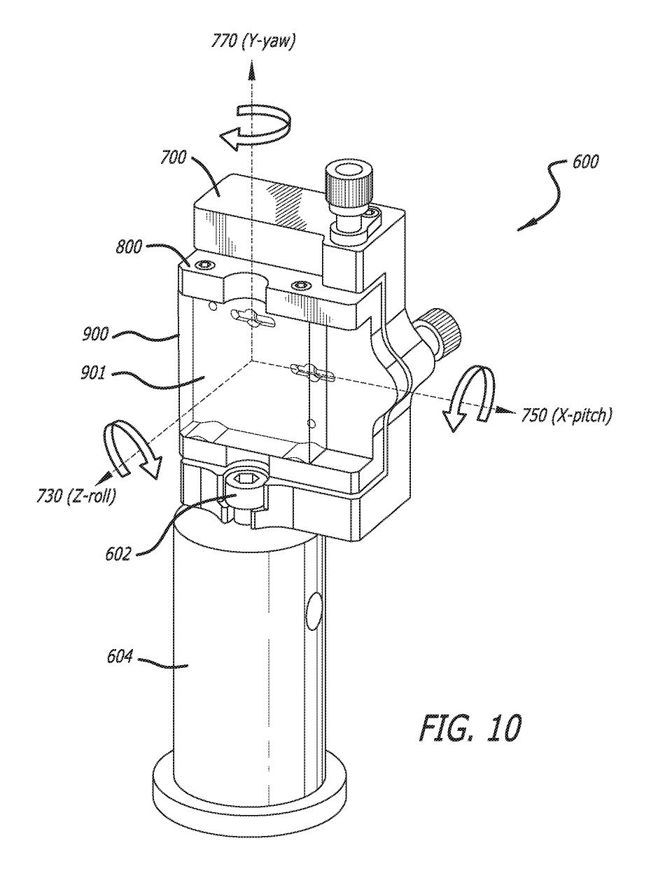

FIGS. 1-9 show an embodiment of the mount 100 in accordance with the description above. Those skilled in the art will appreciate that alternative embodiments may be employed. For example, FIGS. 10-18 illustrate an alternative embodiment of the mount, 600. The mount 600 comprises at least one adjustment assembly 700 and at least one support assembly 800.

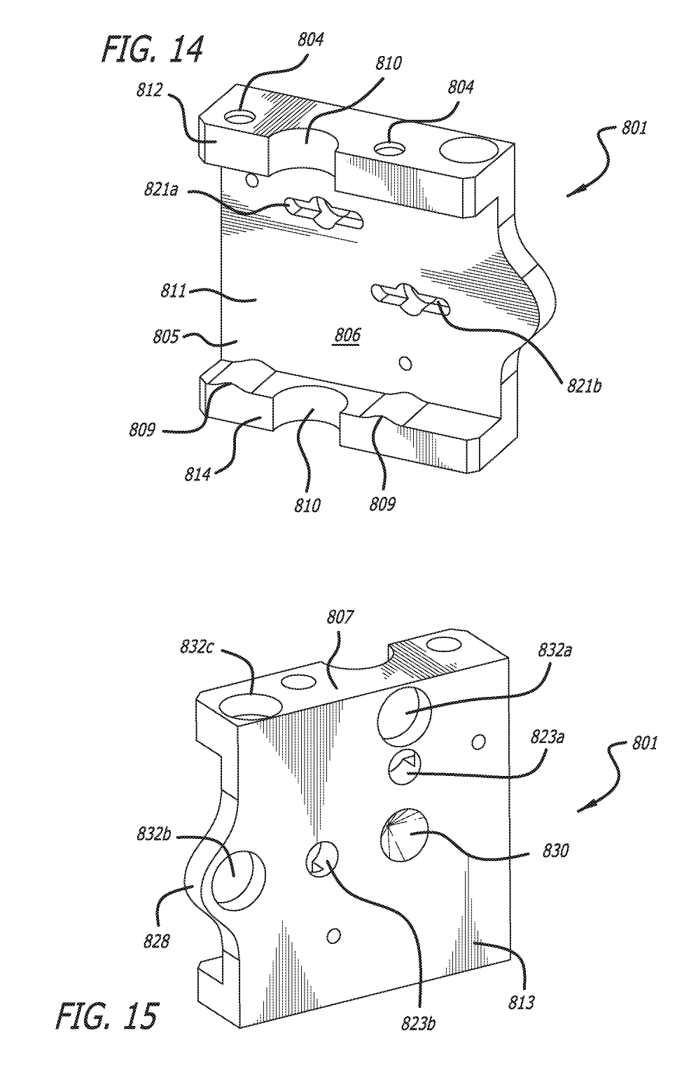

As shown in FIGS. 10, 11, 14, and 15, the support assembly 800 secures the optical component 900 within a component receiving area 806 with one or more securing devices 803. Exemplary securing devices include nylon screws, set screws, nylon-tipped set screws, springs and the like. In the illustrated embodiment, the securing device 803 is a nylon-tipped set screw that traverses through at least one securing device passage 804 (see FIGS. 14 and 15) and engages with the optical component 900 to secure the optical component 900 to the support assembly 800. In the illustrated embodiment, the support assembly 800 secures the optical component 900 in a vertical orientation. Optionally, the support assembly 800 securely supports the optical component 900 in a horizontal orientation or any other orientation. The adjustment assembly 700 is configured to receive the support assembly 800 and provide one or more adjustment device 720 to affect changes to the angular orientation of the support assembly 800.

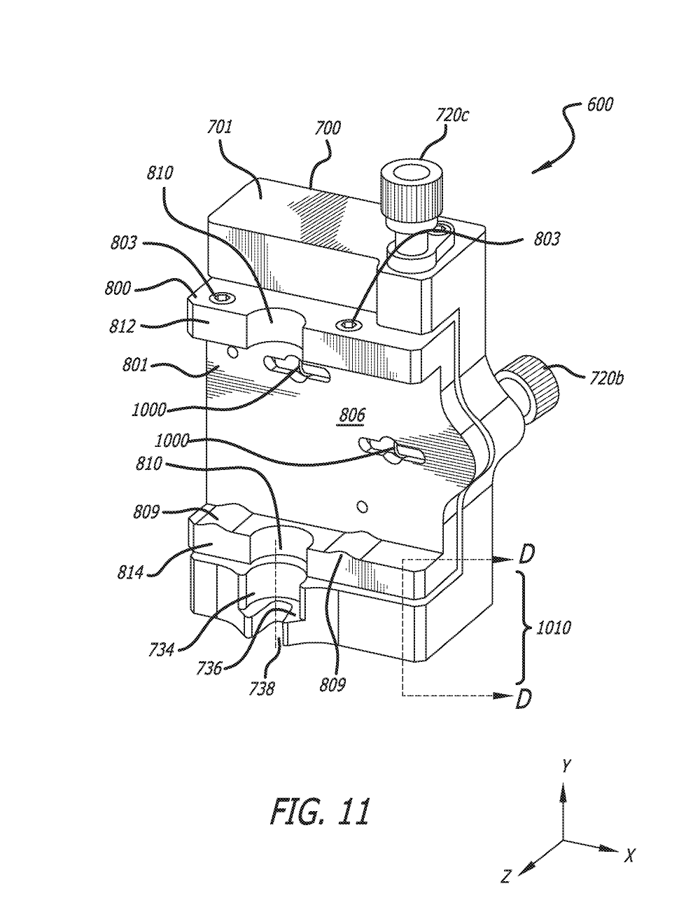

As shown in FIGS. 11-17 show an embodiment of the support assembly 800, having a support body 801 with a pivot assist surface 830 formed in a surface 813 of the support body 801. In this embodiment, the pivot assist surface 830 comprises a conical convex surface. Those skilled in the art will appreciate that the pivot assist surface 830 may be spherical, elliptical, or any other shape.

As shown in FIGS. 11-13, when the adjustment device 720a is actuated, the adjustment member 724a traverses through the adjustment member passage 725a, resulting in a change in angular orientation (pitch) of the support assembly 800 about a pivot body center 820 of a pivot body 822. In the illustrated embodiment, the pivot body 822 is a sphere. Optionally, the pivot body 822 may be elliptical, cylindrical, conical or any of a variety of shapes. The adjustment assembly 700 employs at least one adjustment device 720. In the illustrated embodiment, the adjustment assembly employs three adjustment devices, 720a-c, each configured to provide motion of the support assembly 800 relative to the adjustment assembly 700. Alternatively, the adjustment assembly 700 may use any number of adjustment devices 720. In the illustrated embodiment, the adjustment device 720b adjusts the support assembly 800 in the yaw orientation about the pivot body center 820 of the pivot body 822. The adjustment device 720c provides roll adjustment of the support assembly 800 in the roll orientation about the Z-axis.

As shown in FIGS. 10-13, in the illustrated embodiment of the optical mount 600, the adjustment assembly 700 provides for the rotation of the support assembly 800 about at least one of the X-axis 750 (pitch), a Y-axis 770 (yaw) and a Z-axis 730 (roll).

In one embodiment of the mount 100 described above, the X-axis 250, the Y-axis 270 and the Z-axis 230 may substantially overlap each other at a selected point proximate to the surface 401 of the optical component 400. In one embodiment of optical mount 600, the X-axis 750, the Y-axis 770, and the Z-axis 730 may overlap the pivot body center 820 of the pivot body 822, that is not proximate to the surface 901 of the optical component 900. In another embodiment, the X-axis 750, the Y-axis 770, and the Z-axis 730 may overlap at a selected point that is within the body of the optical component 900, or at a selected point that is proximate to at least one surface of the adjustment body 701 or proximate to at least one surface of the support body 801. In another embodiment, the X-axis 750, the Y-axis 770, and the Z-axis 730 may overlap at a selected point that is within the support body 801 or within the adjustment body 701.

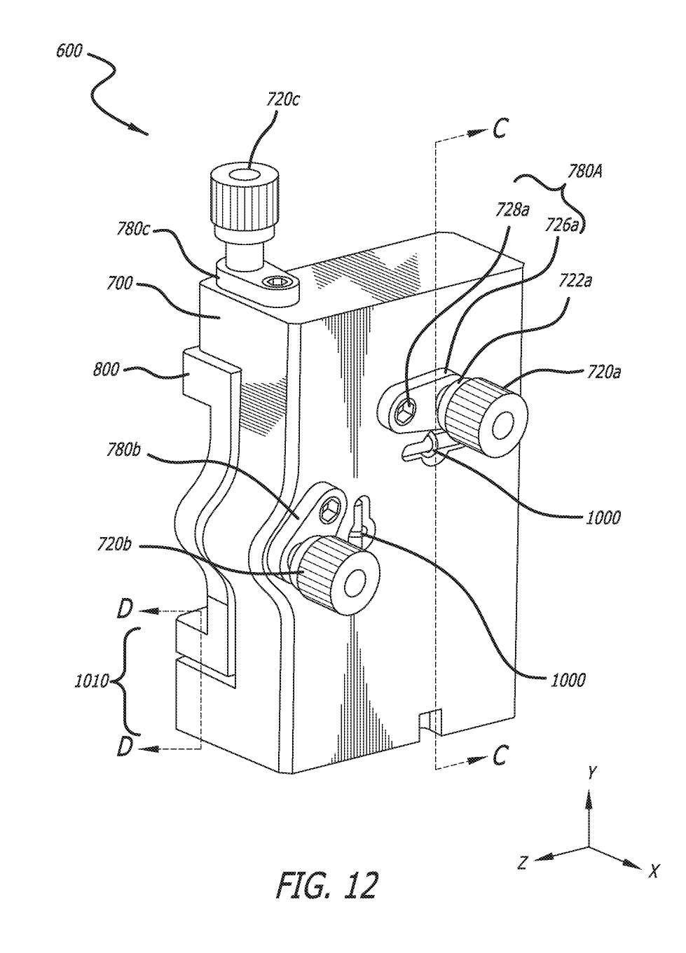

As shown in FIGS. 11 and 12, in the illustrated embodiment, the adjustment assembly 700 comprises at least one pitch adjustment device 720a, at least one yaw adjustment device 720b and at least one roll adjustment device 720b such that engagement of the adjustment devices 720a-c provides angular orientation adjustment of the support assembly 800 to orient the surface 901 of the optical component 900. Those skilled in the art will appreciate that any number of adjustment devices 720 may be used with the adjustment assembly 700. As shown, the adjustment device 720a comprises at least one adjustment effector 724a attached to or integral with at least one adjustment member 722a that traverses through at least one adjustment member passage 725a of the adjustment body 701. Optionally, an external tool (not shown) such as a hex key or wrench may be inserted through at least one of the passages 721a of the adjustment effector 724a, or both, to engage the adjustment member 722a. In the illustrated embodiment, the adjustment member passage 725a has internal threads and the adjustment member 722a has external threads. Exemplary adjustment members 722a-c include coarse-threaded screws with about 20 threads per inch and screws with fine threads, such as 80, 100, 127, 170, 254, or any number of threads per inch. Screws with finer threads enable smoother and more precise control for orientation of the optical component 900. Optionally, the adjustment devices 720a-c may comprise thread-matched adjustment screws, micrometer actuators, piezo-driven rotational actuators, servo-driven rotational actuators, piezo-driven linear actuators and servo-driven linear actuators. Those skilled in the art will appreciate that adjustment devices 720b, 720c may include a similar architecture to adjustment device 720a. Optionally, at least one of the adjustment devices 720a, 720b, 720c may include an alternate design known in the art. Those skilled in the art will appreciate that many types of actuators may be employed in the adjustment devices 720a-c. In the illustrated embodiment, the adjustment members 722a-c are manufactured from steel. Optionally, the adjustment members 722a-c may be manufactured from any variety of materials, including, without limitations, corrosion-resistant steel, copper, brass, bronze, tungsten, various alloys, composite materials, and the like. The adjustment devices 720a-c and/or the support assembly 800 and/or the adjustment assembly 700 may also comprise temperature-compensating devices that reduce or eliminate changes in the dimensions of the mount 600 and/or the position of the optical component 900 due to changes in ambient temperature. Such temperature-compensating devices are described in U.S. patent application Ser. No. 15/713,570—titled “Thermal Compensating Optical Mount and Related Devices”—the contents of which are incorporated herein by reference. In addition, a variety of electronically controlled actuators may be connected to a control system that enables remote control of three axes of motion of the mount 600.

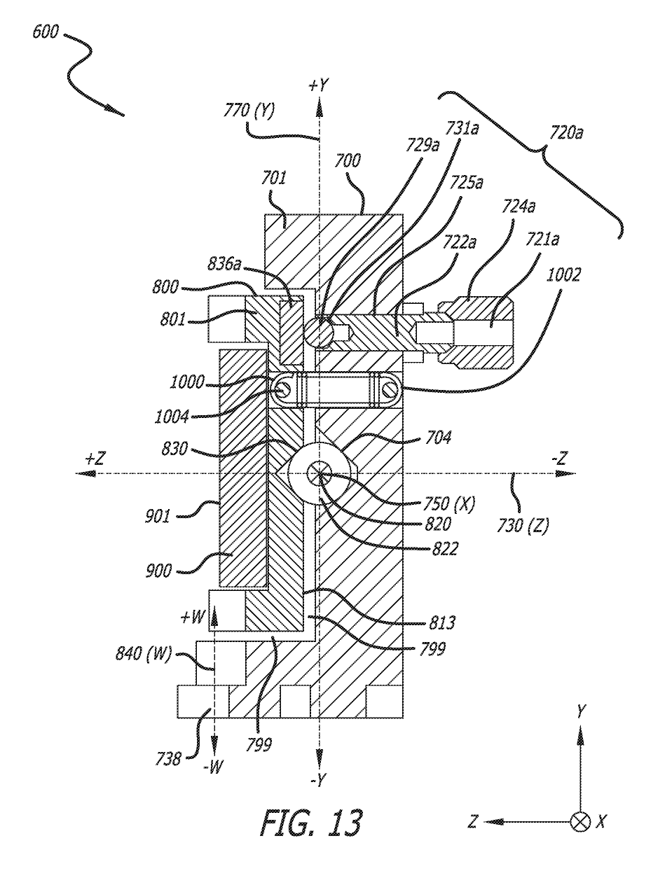

FIG. 13 illustrates a side sectional view A-A of the mount 600. In the illustrated embodiment, the adjustment member 722a comprises at least one engaging member 729a disposed in an engaging member receiving area 731a. The engaging member 729a abuts at least one engaging body 836a that is disposed in at least one engaging body receiving area 832a (see FIGS. 14 and 15) formed in the support body 801. Optionally, the engaging member 729a may contact the surface 813 of the support body 801 (see FIGS. 14 and 15) directly, without the use of the engaging body 836a. Optionally, the adjustment member 722a may not comprise an engaging member 729a but instead may be formed as a monolithic body with a rounded, conical, flat or any other shape end that abuts the engaging body 836a or the surface 813. In one embodiment, the engaging body 836a is manufactured from carbide. Optionally, the engaging body 836a is manufactured from at least one material selected from the group consisting of steel, aluminum, alloys, tungsten, sapphire, composite materials, polymers, elastomers, and the like.

Referring to FIGS. 11-17, at least one biasing system 1000 including at least one biasing body 1002 extends through at least one biasing member passage 823a-b in the support body 801 and through at least one biasing member passage 712a-b formed in the adjustment body 701. The biasing bodies 1002 are retained by the biasing system retaining members 1004 located within as least one retaining device receiver 732a-b formed in the surface 705 of the adjustment body 701, and by retaining device receivers 821a-b formed in the surface 805 of the support body 801, respectively. For example, in one embodiment, the biasing body 1002 comprises a spring device. Exemplary materials for the biasing body 1002 are spring steel, corrosion-resistant steel, nickel-based super-alloys, shape-memory alloys, super-elastic alloys, and the like. Optionally, the biasing body 1002 may comprise a leaf spring, flexure device, kinematic biasing device or other device that provides a biasing force to urge the support assembly 800 against the adjustment device 720a. During use, the biasing system 1000 is configured to couple the adjustment assembly 700 and the support assembly 800 in a movable relation. As such, at least a portion of the biasing system 1000 is configured to traverse through at least one positioning relief 799 formed between the support assembly 800 and the adjustment assembly 700. Those skilled in the art will appreciate that any number of biasing systems of any variety may be used with the mount 600.

As shown in FIGS. 10-13, in the illustrated embodiment, when the adjustment effector 724a is turned in a clockwise direction, the adjustment member 722a moves in the positive Z-direction, causing the support assembly 800 to pivot in a counterclockwise direction (around the X axis 750 (pitch) from the perspective of FIGS. 10 and 13) against the biasing force of the biasing system 1000, resulting in a change in the angular orientation of the optical component 900. When the adjustment effector 724a is turned in the counterclockwise direction, the adjustment member 722a moves in the negative Z-direction, and the biasing system 1000 forces the support assembly 800 to pivot in the clockwise direction around the X axis. The adjustment device 720a may be removable and replaced with the optional adjustment devices or actuators described above for mechanically or electronically adjusting the orientation of the optical component 400 about the X-axis 750 (pitch).

Referring to FIGS. 10-13, the adjustment assembly 700 shows at least three adjustment devices 720a-c, each configured to provide motion of the support assembly 800 relative to the adjustment assembly 700. As such, in a similar manner to that described above, the adjustment device 720b adjusts the support assembly 800 about the Y-axis 250 (yaw), and the adjustment device 720c adjusts the support assembly 800 about the Z-axis (roll).

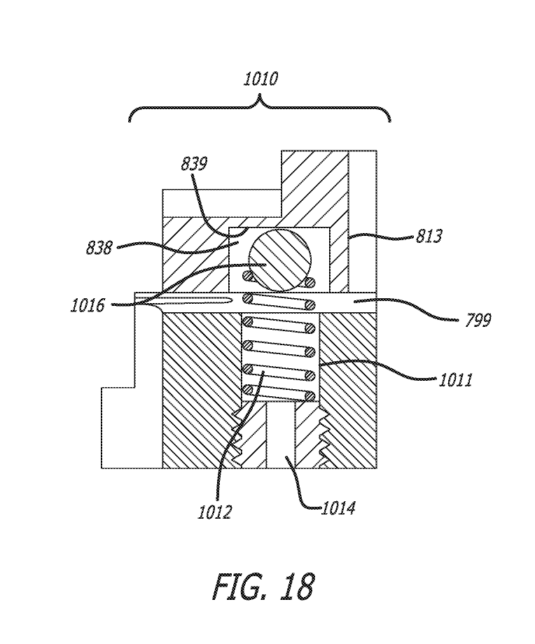

As shown in FIGS. 11-14 and 16-18, at least one biasing system 1010 is configured to provide biasing force to the adjustment device 720c for the Z-axis (roll)—see section D-D in FIG. 18. At least one biasing body passage 1011 is formed in the flange 718 of the adjustment body 701. At least one biasing body 1012 traverses through the biasing body passage 1011 and the positioning relief 799 and engages with at least one engaging member 1016 disposed in at least one biasing system relief 838 of the support body 801. Optionally, the biasing system 1010 operates without the engaging member 1016, and the biasing body 1012 engages with the biasing system relief 838 directly. The biasing body 1012 is retained in the biasing body passage 1011 by at least one biasing body retainer 1014. In the illustrated embodiment, the biasing body 1012 is a spring. Exemplary materials for the biasing body 1012 are spring steel, corrosion-resistant steel, nickel-based super-alloys, shape-memory alloys, super-elastic alloys, and the like. Optionally, the biasing body 1012 may comprise a leaf spring, flexure device, kinematic biasing device or other device that provides a biasing force to urge the support assembly 800 against the adjustment device 720c.

Referring to FIGS. 10-18, as discussed above, the adjustment assembly 700 comprises at least three adjustment devices 720a-c. Each of the adjustment devices 720a-c operates with a corresponding biasing system 1000 or 1010 to provide a biasing force that urges the support assembly 800 against the adjustment devices, thereby resulting in controlled changes in orientation of the optical component 900.

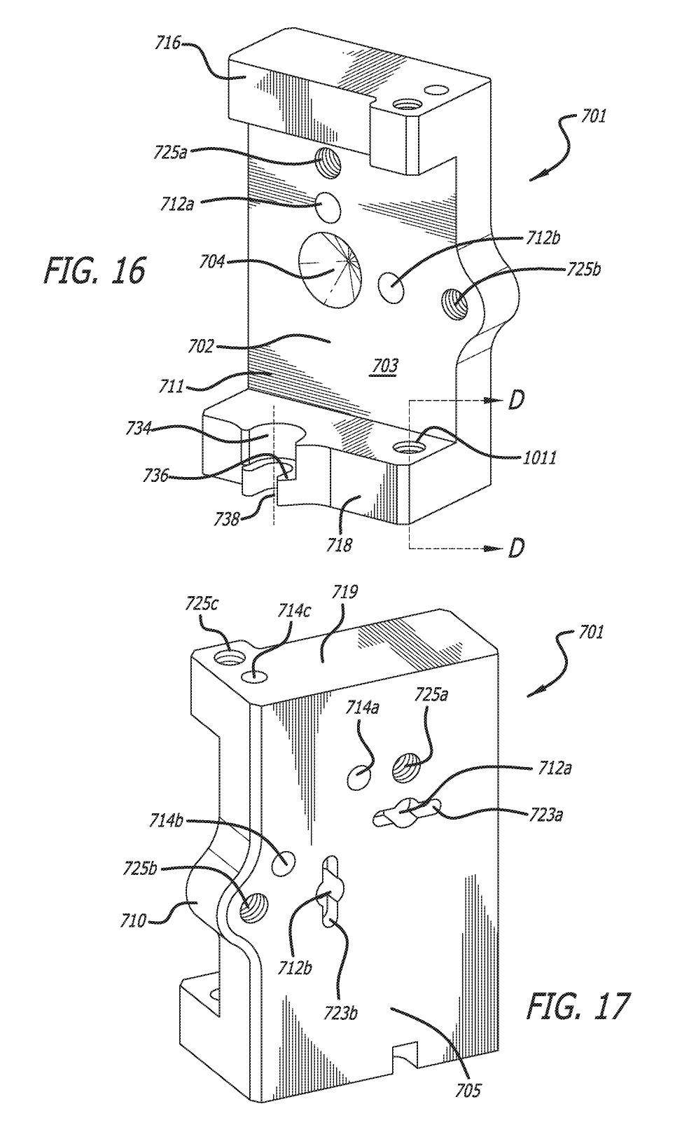

As shown in FIGS. 11-12 and 16-17, the adjustment assembly 700 may further comprise at least one adjustment member lock 780a for selectively preventing the movement of the X-axis adjustment device 720a once set to a desired orientation. The adjustment member lock 780a comprises at least one locking member 726a in communication with the adjustment member 722a at the proximal region of the locking member 726a. Additionally, the adjustment member lock 780a may further include at least one fastener device 728a situated within the distal portion of the locking member 726a. The fastener device 728a may engage with at least one locking member receiving area 714a that is formed in the adjustment body 701 (see FIGS. 16 and 17) and urge the distal portion of the locking member 726a away from the surface 705, thereby preventing the movement of the adjustment member 722a. Optionally, the fastener device 728a may contact the surface 705 of the adjustment body 701 directly. Those skilled in the art will appreciate that other adjustment member locks known in the art may be employed to hold the adjustment member 722a in a desired location. As shown in FIGS. 1-3, the adjustment assembly 700 shows that all three adjustment devices 720a, 720b and 720c are configured with corresponding adjustment member locks 780a, 780b and 780c respectively. Optionally, the adjustment devices 720a-c may operate without the adjustment member locks 780a-c.

As shown in FIGS. 14 and 15, the support body 801 comprises at least one plate body 811 with one or more surfaces 805 and 813 and with one or more flanges 812 and 814 formed thereon or integral thereto. In one embodiment, the flanges 812 and 814 are formed on the plate body 811 to create a monolithic body. In another embodiment, the plate body 811 and flanges 812 and 814 are formed from separate members. In the illustrated embodiment, the plate body 811 and the flanges 812 and 814 define at least one optical component receiving area 806. In the illustrated embodiment, the flanges 812 and 814 are horizontally arranged. Optionally, the flanges 812 and 814 may be vertically arranged or arranged in other orientations. The support body 801 further comprises at least one raised feature 809 formed on the flange 814 and configured to support the optical component 900. At least one securing device passage 804 is formed in the flange 812. In the illustrated embodiment, at least one engaging body receiving area 832c is formed in the surface 807 of the support body 801. Optionally, no engaging body receiving area 832c is formed in the support body 801. At least one relief 810 is formed in flange 812 and in flange 814, being substantially coaxial with each other to allow access to the fastener 602 (see FIG. 10). In the illustrated embodiment, the relief 810 is a radius. Optionally, the relief 10 may be square, rectangular, triangular, or other shape. At least one extended area 828 is formed on the plate body 811, with at least one engaging body receiving area 832b formed therein. Optionally, the extended area 828 may not have the engaging body receiving area 832b formed therein.

In the illustrated embodiments, the support body 801 and the adjustment body 701 are made from aluminum. Optionally, the support body 801 and the adjustment body 701 may be made from steel, corrosion-resistant steel, sintered metals, titanium, shape-memory alloys, super-alloys such as Inconel, Kovar, Invar and others, thermoplastics, thermoset polymers, carbon-fiber reinforced plastics and the like. Those skilled in the art will appreciate that the support body 801 and the adjustment body 701 may be made from many other materials.

Referring to FIGS. 16 and 17, in one embodiment, the adjustment body 701 comprises at least one plate body 702 with surfaces 711 and 705 and with one or more flanges 716 and 718 formed thereon or integral thereto, defining a support body receiving area 703. In one embodiment, the flanges 716 and 718 are formed on the plate body 702 to form a monolithic adjustment body 701. In another embodiment, the plate body 702 and the flanges 716 and 718 are formed from separate members. In the illustrated embodiment, flanges 716 and 718 are horizontally arranged. Optionally, flanges 716 and 718 may be vertically arranged or arranged in other orientations. In the illustrated embodiment, the adjustment body 701 further comprises at least one extended region 710 formed on the plate body 702. At least one passage 725b is formed in the extended region 710. The passage 725b is configured to receive the adjustment device 720b for the yaw adjustment of the support assembly 800. In similar fashion, at least one passage 725c is formed in the surface 719 of the adjustment body 701, with at least one locking member receiving area 714c formed proximal thereto. The passage 725c is configured to receive the adjustment device 720c for roll adjustment of the support assembly 800. At least one pivot assist surface 704 is formed in the surface 711 of the plate body 702. In this embodiment, the pivot assist surface 704 comprises a conical concave surface. Those skilled in the art will appreciate that the pivot assist surface 704 may be spherical, elliptical, convex or concave or any other shape.

As shown in FIGS. 10, 13 and 16, in one embodiment, the mount 600 may include at least one coupler channel 734 or similar feature permitting the optical mount 600 to be selectively coupled to or movably coupled to at least one optical post 604, fixture, structure and/or similar component. For example, in the illustrated embodiment, the mount 600 includes a single coupler channel 734 formed in at least a portion of the flange 718. As shown, the coupler channel 734 may include at least one fastener recess 738 and at least one fastener flange 736 formed within the coupler channel 734. Further, as shown, in one embodiment the fastener recess 738 traverses through the flange 718, thereby permitting at least one fastener 602 positioned within the coupler channel 734 to selectively engage and be retained by the optical post 604. For example, during use the user may position at least one fastener 602 within the coupler channel 734 and actuate the fastener 602 such that the fastener engages the fastener flange 736, traverses through the flange 718 and engages at least a portion of the optical post 604, thereby securely coupling the mount 600 to the optical post 604.

In one embodiment, the coupler channel 734 and/or the fastener recess 738 may define at least one fourth, W-axis 840. In one embodiment, the W-axis 840 may substantially overlap one or more of the X-axis 750, the Y-axis 770 and the Z-axis 730 (see FIG. 13). Optionally, the W-axis 840 may overlap none of the X-axis 750, the Y-axis 770 or the Z-axis 730.

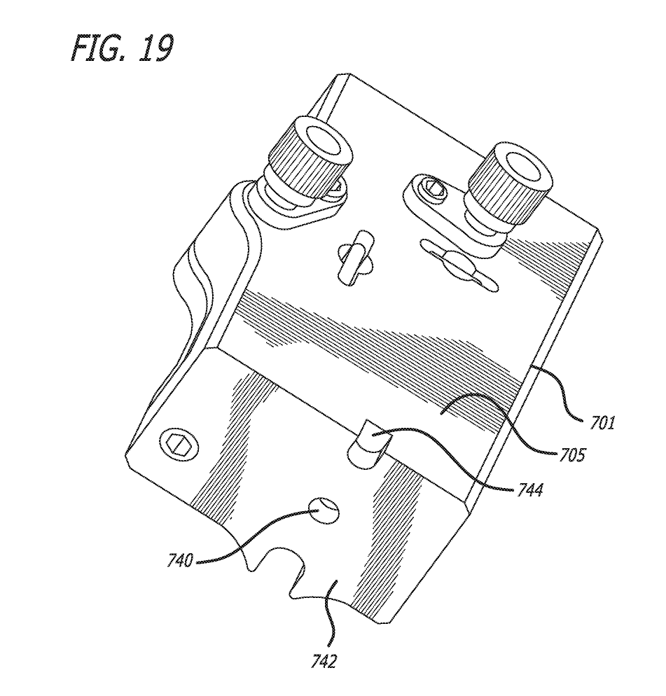

In another embodiment, and shown in FIG. 19, the optical mount 600 may be fixed in place by one or more fasteners or pins (not shown) that may be inserted into at least one first fastener port 740 formed in the surface 742 of the adjustment body 701 to detachably couple the mount 600 to a variety of surfaces, including lasers systems, opto-mechanical systems, motion control systems, and the like. In the illustrated embodiment, the first fastener port 740 is a cylindrical blind hole with a smooth surface configured to mate with a pin or similar fastener mounted in an external surface. Optionally, the first fastener port 740 may include internal threads configured to accept a threaded fastener. Additionally, at least one second fastener port 744 may be formed in surface 742. In the illustrated embodiment, the fastener port 744 comprises a slot that extends from the bottom surface 742 through the adjacent surface 705. Alternatively, the fastener port 744 may be a variety of shapes or configurations.

While an improved mount is disclosed by reference to the various embodiments and examples detailed above, it should be understood that these examples are intended in an illustrative rather than limiting sense, as it is contemplated that modifications will readily occur to those skilled in the art which are intended to fall within the scope of the present invention.

What is claimed is:

1. A mount for an optical component, comprising:
at least one support assembly having at least one support body;
at least one adjustment assembly having at least one adjustment body and in communication with the at least one support assembly;
at least one first adjustment device positioned on the at least one adjustment body the first device and configured to engage and rotate the at least one support assembly about at least a first axis;
at least one second adjustment device positioned on the at least one adjustment body and configured to engage and rotate the at least one support assembly about at least a second axis, the at least one second axis substantially orthogonal to the at least one first axis; and
at least one third adjustment device positioned on the at least one adjustment body and configured to engage and rotate the at least one support assembly about at least one third axis, the at least one third axis substantially orthogonal to the at least one first axis and the at least one second axis, wherein the at least one first axis, the at least one second axis and the at least one third axis are configured to substantially overlap at least one selected point.

2. The mount of claim 1, wherein the at least one adjustment device is selected from the group consisting of linear actuators, rotating actuators, micrometer actuators, piezo-driven actuators, servo-driven actuators, and thread-matched actuators.

3. The mount of claim 2, wherein the at least one support body is configured to support at least one optical component having at least one optical component body.

4. The mount of claim 3, wherein the at least one optical component is selected from the group consisting of diffraction gratings, mirrors, prisms, beam splitters, and holographic gratings.

5. The mount of claim 4, wherein the at least one selected point is located proximal to at least one surface of the at least one optical component.

6. The mount of claim 4, wherein the at least one selected point is not located proximal to at least one surface of the at least one optical component.

7. The mount of claim 4, wherein the at least one selected point is located within the at least one optical component body of the at least one optical component.

8. The mount of claim 4, wherein the at least one selected point is not located within the at least one optical component body of the at least one optical component.

9. The mount of claim 1, wherein the at least one selected point is located proximal to at least one surface of the at least one adjustment body.

10. The mount of claim 1, wherein the at least one selected point is not located proximal to at least one surface of the at least one adjustment body.

11. The mount of claim 1, where the at least one selected point is located proximal to at least one surface of the at least one support body.

12. The mount of claim 1, where the at least one selected point is not located proximal to at least one surface of the at least one support body.

13. The mount of claim 1, wherein the at least one selected point is located within the at least one support body or within the at least one adjustment body.

14. A mount for an optical component, comprising:
at least one support assembly having at least one support body;
at least one adjustment assembly having at least one adjustment body and in communication with the at least one support assembly;
at least one first adjustment device positioned on the at least one adjustment body and configured to engage and rotate the at least one support assembly about at least a first axis;
at least one second adjustment device positioned on the at least one adjustment body and configured to engage and rotate the at least one support assembly about at least a second axis that is substantially orthogonal to the at least one first axis;
at least one third adjustment device positioned on the at least one adjustment body and configured to engage and rotate the at least one support assembly about at least one third axis that is substantially orthogonal to the at least one first axis and the at least one second axis, wherein the at least one first axis, the at least one second axis and the at least one third axis substantially overlap a selected point; and
at least one coupler channel formed on the at least one adjustment body and defining a fourth axis that substantially overlaps at least one of the first, second or third axes, the coupler channel configured to receive at least one fastener configured to couple the adjustment body to at least one optical post or surface.

15. The mount of claim 14, wherein the at least one adjustment device is selected from the group consisting of linear actuators, rotating actuators, micrometer actuators, piezo-driven actuators, servo-driven actuators, and thread-matched actuators.

16. The mount of claim 14, wherein the at least one support body is configured to support at least one optical component having at least one optical component body.

17. The mount of claim 16, wherein the at least one optical component comprises a diffraction grating.

18. The mount of claim 16, wherein the optical component is selected from the group consisting of mirrors, prisms, beam splitters, and holographic gratings.

19. The mount of claim 18, wherein the at least one selected point is located proximal to at least one surface of the at least one optical component.

20. The mount of claim 18, wherein the at least one selected point is not located proximal to at least one surface of the at least one optical component.

21. The mount of claim 18, wherein the at least one selected point is located within the at least one optical component body of the at least one optical component.

22. The mount of claim 18, wherein the at least one selected point is not located within the at least one optical component body of the at least one optical component.

23. The mount of claim 14, wherein the selected point is located proximal to at least one surface of the at least one adjustment body.

24. The mount of claim 14, wherein the selected point is not located proximal to at least one surface of the at least one adjustment body.

25. The mount of claim 14, where the at least one selected point is located proximal to at least one surface of the at least one support body.

26. The mount of claim 14, where the at least one selected point is not located proximal to at least one surface of the at least one support body.

27. The mount of claim 14, wherein the at least one selected point is located within the at least one support body or within the at least one adjustment body.

28. A mount for an optical component, comprising:
at least one support assembly having at least one support body;
at least one adjustment assembly with at least one adjustment body and in communication with the at least one support assembly;
at least one first pivot assist surface formed in the at least one support body of the at least one support assembly and configured to receive at least one pivot body;
at least one second pivot assist surface formed in the at least one adjustment body of the adjustment assembly and configured to receive at least one pivot body;
at least one pivot body with at least one pivot body center, positioned between the at least one first pivot assist surface formed in the at least one support body and the at least one second pivot assist surface formed in the at least one adjustment body;
at least one first adjustment device positioned on the at least one adjustment body and configured to engage and rotate the support assembly about at least a first axis, the at least one first axis substantially overlapping the at least one pivot body center;
at least one second adjustment device positioned on the at least one adjustment body and configured to engage and rotate the at least one support assembly about at least a second axis that is substantially orthogonal to the at least one first axis and substantially overlapping the at least one pivot body center; and
at least one third adjustment device positioned on the at least one adjustment body and configured to engage and rotate the at least one support assembly about at least one third axis that is substantially orthogonal to the at least one first axis and the at least one second axis, wherein the at least one first axis, the at least one second axis and the at least one third axis substantially overlap the at least one pivot body center.

29. The mount of claim 28, wherein the at least one adjustment device is selected from the group consisting of linear actuators, rotating actuators, micrometer actuators, piezo-driven actuators, servo-driven actuators, and thread-matched actuators.

30. The mount of claim 28, wherein the at least one support body is configured to support at least one optical component.

31. The mount of claim 30, wherein the at least one optical component is selected from the group consisting of diffraction gratings, mirrors, prisms, beam splitters, and holographic gratings.
